(19) United States
(12) Patent Application Publication
(10) Pub. No.: US 2006/0045232 A1
(43) Pub. Date: Mar. 2, 2006

(54) Non shadow forming spacers and hardware for a BWR fuel assembly

(75) Inventor: Kurt Ward Edsinger, Pleasanton, CA (US)

Correspondence Address: NIXON & VANDERHYE P.C., 901 NORTH GLEBE ROAD, 11TH FLOOR, ARLINGTON, VA, 22203, US

(73) Assignee: Global Nuclear Fuel - Americas, LLC, Wilmington, NC (US)

(21) Appl. No.: 10/927,202

(22) Filed: Aug. 27, 2004

(51) Int. Cl. G21C 3/34

(52) U.S. Cl. 376/442

(57) ABSTRACT

A new type of coated component for use in boiling water reactor (“BWR”) fuel assemblies, particularly Zircaloy spacers, having protective coatings applied to selected surfaces of the spacers in order to prevent the formation and propagation of “shadow corrosion” on adjacent zirconium alloy structures. In its broader aspects, the coating material is applied to those surfaces of the BWR components having electro-chemical characteristics that differ from zirconium alloys, such as Inconel spacers or springs. The new coatings impart an electro-chemical potential to the surfaces of the components that is substantially similar to the adjacent zirconium alloy, thereby preventing or significantly inhibiting shadow corrosion.

### BACKGROUND OF THE INVENTION

The present invention relates to components used in boiling water reactor (“BWR”) fuel assemblies and, in particular, to a new type of spacer having protective coatings on selected surfaces of the spacer that prevent the formation and propagation of “shadow corrosion” on adjacent zirconium alloy structures. In its broader aspects, the invention provides a coating material that is applied to the surfaces of non-zirconium BWR components, such as Inconel spacers or springs, having electro-chemical characteristics that differ from zirconium alloys. The new coatings impart an electro-chemical potential to the surfaces of the components that is substantially the same as adjacent zirconium alloy structures (such as Zircaloy claddings used on fuel rods), thereby preventing or significantly inhibiting shadow corrosion on the zirconium alloy components and effectively increasing the lifespan of the entire fuel bundle.

Modern nuclear fuel bundles for boiling water nuclear reactors include a matrix (or “bundle”) of vertical upstanding and sealed nuclear fuel rods. Typically, the fuel bundles are held together by a lower tie plate that supports the fuel rods and permits the entry of water and an upper tie plate that permits the outflow of water and generated steam. Some of the fuel rods connect directly to the tie plates and thus assist in holding the fuel rods together as a discrete unit. The fuel bundle is then placed inside a channel.

In operation, the channel directs the flow of cooling water discretely through the rods making up the fuel bundle. The individual rods are long, typically on the order of 160 inches, and relatively slender. Given the dynamics of steam generation, without some form of restraint or structural support, the fuel rods vibrate during operation such that they make abrading contact with one another. For that reason, the art has developed fuel rod spacers that discretely surround each fuel rod (without inhibiting the flow of cooling water), forming an integrated matrix of fuel rod cells. Generally, five to nine spacers are utilized at differing elevations along the length of the fuel bundle which hold the fuel rods at differing positions along their entire length in a centered relationship.

Most conventional spacer cells have two structures acting on the fuel rods, namely the stops and springs that help to align, center and stabilize the fuel rods. Normally, the fuel rods are biased by one or more springs into the stops of each spacer cell and the rods thereby become centered in their matrix position. Zirconium alloy spacers typically consist of Zircaloy cells, but with individual rod stops comprised of a different metal. Likewise, the springs often consist of Inconel, with the springs being held in place by surrounding parts of the Zircaloy cells.

Recent corrosion studies of components subjected to nuclear irradiation indicate that zirconium-based alloy components often suffer localized enhanced corrosion in a radiation field if they are positioned adjacent to materials having a dissimilar electro-chemical potential to the zirconium alloy, such as Inconel. This localized corrosion effect, known as “shadow corrosion,” occurs in the presence of a radiation field that can enhance the conductivity of the involved components and change the properties of the water by a process known as radiolysis. These changes in the environment induce locally higher corrosion currents in the zirconium-based alloy, producing a “shadow” corrosion image on the alloy. As a result, the useful life of the alloys may be limited by both the localized shadow corrosion and an increase in hydrogen due to the formation of oxides and resultant changes in alloy volume.

Thus, it is known that two components having different corrosion characteristics placed in close proximity to each other can, under BWR conditions, influence the corrosion behavior of each other. The most common occurrences include the Zircaloy channel surface in the core bypass region (where the handle of the control blade or the top guide are positioned close to the channel surface) and on Zircaloy fuel cladding in direct contact with the spacers or spacer springs. As noted above, the effect is most dramatic with an Inconel spacer or spring adjacent to the Zircaloy fuel cladding. The end result in such cases is an increase in the formation of corrosion oxide on the Zircaloy cladding. This increased corrosion creates a visible mark on the surface called a “shadow.”

One early approach to mitigating shadow corrosion relied on low manganese stainless steels. If manganese is removed from certain stainless steels used in components subjected to a high neutron environment, the stress corrosion resistance of the components decreases. The reduction or elimination of manganese also increases the probability that at least a portion of the stainless steel will undergo a diffusionless martensite transformation to produce martensite, the presence of which is known to reduce the stress corrosion cracking resistance of stainless steel. Thus, in order to compensate for the reduction or loss of manganese, other compensatory austenite-stabilizing alloying elements, such as nickel, carbon and/or nitrogen, have been added to the stainless steel.

Although lowering the level of manganese can serve to reduce the shadow corrosion effect, any modification to the composition of a stainless steel for a nuclear reactor core component requires an extensive and time-consuming qualification, including complete metallurgical and fabrication evaluation using both laboratory and in-reactor corrosion testing. In addition to the expense and time involved, that process has an uncertain probability of success. Accordingly, a more efficient approach is needed to reduce shadow corrosion within a nuclear reactor core without requiring any modification to the basic compositions of its metal components.

Another known common approach to minimizing the effect of shadow corrosion in BWR assemblies has been to reduce the amount of the known shadowing material in close proximity with the zirconium alloy. In the case of fuel claddings and spacers, spacers fabricated from a zirconium alloy are more common. Unfortunately, the use of zirconium alloy spacers is not an optimum solution to preventing shadowing because components made from zirconium alloys lack the mechanical strength and structural integrity of Inconel-type alloys. Thus, the components must be made thicker in order to maintain adequate strength. The increase in thickness invariably increases the pressure drop of coolant through the fuel bundle and can adversely effect critical power and shut down margins. Another drawback of zirconium alloy spacers is that in order to avoid excessive relaxation, the spring in the zirconium alloy spacer must still be made from Inconel. Although it has much less surface area than the rest of the spacer, as noted above Inconel springs have been found to cause a measurable shadow on any adjacent zirconium components.

### BRIEF DESCRIPTION OF THE INVENTION

The present invention provides a new type of structure and method for improving the corrosion resistance of zirconium-based alloy components in a nuclear reactor environment. In its broader aspects, the invention provides an electrically compatible coating on the surface of the component facing or contacting the zirconium alloy that may cause shadowing. The coating reduces or eliminates the shadow formation on the zirconium alloy by eliminating a root cause of such shadowing, namely the differences in electro-chemical potential of adjacent BWR components.

### BRIEF DESCRIPTION OF THE DRAWINGS

FIG. 1 is a perspective view of a spacer cell and fuel rod having a coating strategically applied to portions of the spacer in accordance with the invention;

FIG. 2 is a perspective view of a conventional fuel bundle showing the relative position of coated spacers in accordance with the invention as part of a completed fuel assembly; and

FIG. 3 is a plan view of a segment of an exemplary spacer assembly for a fuel bundle having coatings according to the invention.

### DETAILED DESCRIPTION OF THE INVENTION

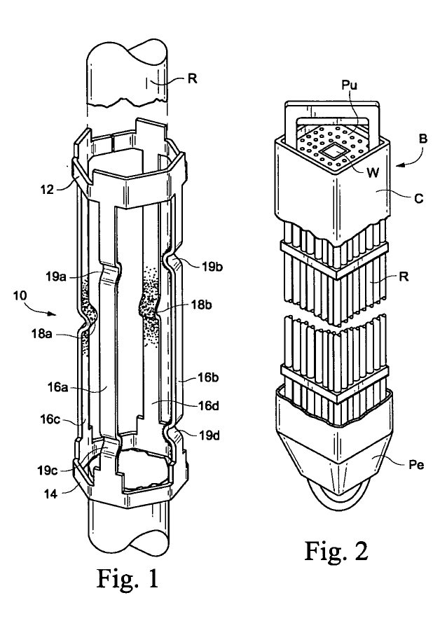

Referring to FIG. 1, an exemplary spacer cell for holding a nuclear fuel rod within a spacer and having a coating according to the present invention is depicted generally at 10. The single spacer cell shown in FIG. 1 (which forms part of an integrated matrix of cells forming the spacer) includes upper octagonal crown 12 and lower octagonal crown 14. Spacers of the type shown in FIG. 1 having integral springs and dual octagonal crowns are described in commonly-owned U.S. Pat. No. 5,361,288 to Johansson, entitled “Spacer with Integral Zircaloy Springs.” The spacer cells shown in FIG. 1 are specifically designed to allow the spring and stop portions to contact only selected portions of the fuel rod cladding shown generally as R.

As noted above, the areas of direct contact between diverse metallurgical components (such as components made of zircaloy and Inconel), as well as those areas in close proximity to one another, may give rise to unwanted “shadow corrosion.” All such areas between diverse metallurgical components are candidates for the coatings as described herein.

FIG. 1 depicts an exemplary spacer design having a coating applied in accordance with the invention. As those skilled in the art will appreciate, the same or similar coatings can be applied to parts of other spacer designs having diverse metallurgical components depending on the specific metallurgy involved and the configuration of the fuel rod spacer. As one example, coatings according to the invention could be used on conventional double-sided spring members and ferrules such as those depicted in commonly-owned U.S. Pat. No. 4,508,679 to Matzner et al, entitled “Nuclear Fuel Assembly Spacer.” The exact location and amount of coatings applied to diverse fuel rod spacer components (particularly those with zircaloy ferrules and Inconel springs) may vary, depending on the particular spring design and end use application.

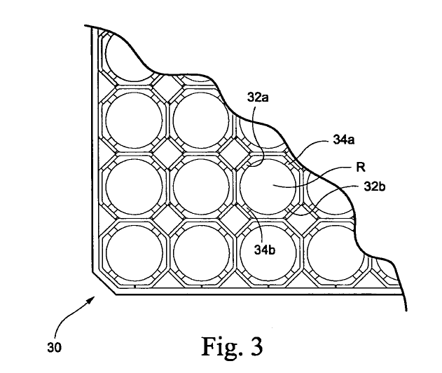

With respect to the illustrative embodiment in FIG. 1, the spacer includes a set of four spacer cell legs shown as 16a, 16b, 16c and 16d, respectively. Legs 16a and 16b each contain two distally positioned stops, 19a, 19b, 19c and 19d, which serve to align and center the spacer cells around each fuel rod. In like manner, legs 16c and 16b each include spring biasing means 18a and 18b medially positioned on each leg. The spring means serve as biasing points of contact with the fuel rod R as shown. Thus, in order to bias the fuel rod in a centered position with respect to the cells, a “stop” point is formed on each leg by virtue of the inwardly arcuate portions 19a, 19b, 19c and 19d which in turn are biased against the fuel rod by spring means 18a and 18b. A plurality of spacer cells, each having legs and biasing means as described above, can be joined together at their crowns to form a completed spacer assembly in the manner depicted in FIG. 3.

Referring now to FIG. 2, a perspective view of a fuel bundle is depicted generally at 20 showing the relative position of coated spacers according to the invention within a completed fuel assembly. Fuel bundle B in FIG. 2 is shown surrounded by a channel C, which in turn is shown broken away to illustrate an exemplary matrix of fuel rods R having a central water rod W. The fuel rods extend between lower tie plate P₁ and upper tie plate Pᵤ. The locations of two spacer assemblies is also illustrated schematically.

FIG. 3 shows a plan view of a segment of an exemplary spacer assembly 30 for use in a fuel bundle having a coating on portions of the springs according to the invention. As noted above, spacer assembly 30 typically comprises an integral matrix of individual spacer cells of the type depicted in FIG. 2. A plurality of fuel rods R, each having a Zircaloy cladding tube, are held in place by Inconel springs joined at their crowns and with four legs, each including stops 32a and 32b and spring biasing means 34a and 34b. The spring biasing means are medially located in each leg as described above and positioned such that the springs and stops contact only a small portion of the cladding as shown in FIGS. 2 and 3. The entire spring and/or selected portions of the spring for each spacer cell, particularly the areas in direct contact with the fuel rod R, are then coated with one or more electrically compatible coatings in accordance with the invention, i.e., coatings having the same or substantially similar electro-chemical potential. The presence of the coating during normal operation of the BWR tends to preclude any shadow corrosion on the adjacent Zircaloy rod.

The present invention contemplates the use of a number of different types and thicknesses of coatings applied to potential shadow forming, components as described and illustrated above. Although FIGS. 1, 2 and 3 focus on the use of exemplary coatings on individual spacer cells, similar coatings could be applied to any components of the BWR that are electrically dissimilar to adjacent materials, for example the handle of the control blade or the top guide which normally are positioned in contact with or close proximity to the outside channel. See FIG. 2.

Exemplary coatings according to the invention exhibit chemical properties that tend to make them stable in a BWR environment, and thus will resist cracking or spalling off. Preferably, the coatings should also have a corrosion potential that is similar to the adjacent zirconium alloy. It has also been found that exemplary thicknesses of the coatings range between about 10 microns and 5 mils, depending on the specific coatings involved. Those skilled in the art will appreciate that the exact amount of coating may vary, depending on the particular fuel rod spacer design involved, In practice, it has been found that all surfaces within about 5 mm of the fuel clad surface may need to be coated. It may also be useful to coat the entire inner facing surface of the spacer grid and spring assembly.

Coatings of both zirconium oxide and zirconium (which would be converted to an oxide form by the in-reactor corrosion) can be tailored to provide the dissimilar component with virtually the same electro-chemical potential as the adjacent zirconium alloy structure. Other types of coatings with similar corrosion potentials can also be formulated to provide the same electro-chemical potential as Zircaloy. For example, both the metals and oxides of Zr, Ti, Ni and Cr are candidates for coatings and coated articles according to the invention. A number of other alloys would also be expected to provide resistance to shadowing, provided they are electrically compatible with the zirconium alloy component.

### EXAMPLE 1

The results of in-reactor experiments have confirmed that shadowing can be substantially reduced or eliminated by applying one or more coatings on adjacent components that cause the components to be compatible with the zirconium alloy. In order to demonstrate the effectiveness of the anti-shadowing technique according to the invention, a number of different alloys and coatings in close proximity to the Zircaloy were studied to determine their net effect on shadow behavior. The test matrix included three zirconium alloys with zirconium oxide coatings. Two of the samples were plasma-sprayed at three different thicknesses on the coupons (1, 3 and 5 mils). The ends of the coupons were then uncovered. Another specimen used a zirconium oxide coating by a sol-gel process. An Inconel X-705 spring was positioned adjacent to that specimen to determine whether the coating would stop the shadow expected from the spring. The capsule was removed from the reactor and subjected to post-irradiation examination. The coatings demonstrated excellent resistance to the BWR environment.

### EXAMPLE 2

For purposes of comparison, the foregoing experiment placed Inconel, Nitronic, Zircaloy and Platinum coupons next to sections of different types of fuel cladding. Measurable shadows were created on the cladding by both Platinum and Inconel. However, some of the Inconel coupons had been additionally coated with about 4 mils of zirconium oxide and these specimens showed no measurable shadow.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A spacer assembly comprising:
a matrix of spacer cells surrounding a corresponding number of fuel rods, each fuel rod having a cladding tube and each spacer cell having stop means and spring means; and
a coating applied to the surfaces of at least one of said stop means or said spring means in the areas of close proximity to or in contact with the outside surface of said cladding tube, said coating having an electro-chemical potential substantially similar to the electro-chemical potential of said cladding tube.

2. A spacer assembly according to claim 1, wherein said coating comprises zirconium oxide.

3. A spacer assembly according to claim 1, wherein said coating comprises an oxide of Zr, Ti, Ni or Cr.

4. A spacer assembly according to claim 1, wherein said coating comprises an alloy of Zr, Ti, Ni or Cr.

5. A spacer assembly according to claim 1, wherein the thickness of said coating ranges between about 10 microns and 5 mils.

6. A spacer assembly according to claim 1, wherein said cladding tube comprises a zirconium alloy.

7. A spacer assembly according to claim 1, wherein the presence of said coating on said stop means and said spring means inhibits shadow corrosion on said cladding tube.

8. A spacer assembly according to claim 1, wherein said coating comprises zirconium oxide and said stop means and said spring means comprise Inconel.

9. A nuclear fuel bundle for a boiling water reactor comprising a matrix of fuel rods surrounded by a cooling water channel, a lower tie plate, an upper tie plate and at least one spacer assembly for said fuel rods, said spacer assembly comprising a plurality of individual spacer cells surrounding a corresponding number of said fuel rods and having a coating applied to the surfaces of said individual spacer cells in the areas of close proximity or contact between said spacer cells and the outside surface of said fuel rods, said coating having an electro-chemical potential substantially similar to the electro-chemical potential of the outside surface of said fuel rods.

10. A nuclear fuel bundle according to claim 9, wherein said coating comprises zirconium oxide.

11. A nuclear fuel bundle according to claim 9, wherein said coating comprises an oxide of Zr, Ti, Ni or Cr.

12. A nuclear fuel bundle according to claim 9, wherein said coating comprises an alloy of Zr, Ti, Ni or Cr.

13. A nuclear fuel bundle according to claim 9, wherein the thickness of said coating ranges between about 10 microns and 5 mils.

14. A nuclear fuel bundle according to claim 9, wherein said fuel rod comprises a zirconium alloy cladding tube sealed with nuclear fuel.

15. A nuclear fuel bundle according to claim 9, wherein the presence of said coating on said spacer cells inhibits shadow corrosion on the outside surface of said fuel rods.

16. A method for preventing shadow corrosion on component parts of a nuclear fuel bundle, said nuclear fuel bundle comprising a matrix of fuel rods surrounded by a cooling water channel, a lower tie plate, an upper tie plate and at least one spacer assembly for said fuel rods, said method comprising:
applying a coating to the surfaces of individual spacer cells in the areas of close proximity or contact between said spacer cells and the outside surface of said fuel rods, said coating having an electro-chemical potential substantially similar to the electro-chemical potential of the outside surface of said fuel rods.

17. A method according to claim 16, wherein said coating comprises zirconium oxide.

18. A method according to claim 16, wherein said coating comprises an oxide of Zr, Ti, Ni or Cr.

19. A method according to claim 16, wherein said coating comprises an alloy of Zr, Ti, Ni or Cr.

20. A method according to claim 16, wherein the thickness of said coating ranges between about 10 microns and 5 mils.

21. A method according to claim 16, wherein each of said fuel rods comprises a zirconium alloy cladding tube sealed with nuclear fuel.

22. A method according to claim 16, wherein the presence of said coating on said spacer cells inhibits shadow corrosion on the outside surface of said fuel rods.
